(19) United States
(12) Patent Application Publication
(10) Pub. No.: US 2024/0127266 A1
(43) Pub. Date: Apr. 18, 2024

(54) SYSTEM TO AUTHENTICATE A PRODUCT AND A METHOD THEREOF

(71) Applicant: SEPIO PRODUCTS PRIVATE LIMITED, Palghar Maharashtra (IN)

(72) Inventors: Murad Nathani, Maharashtra (IN); Paul Abner Noronha, Maharashtra (IN); Darshan Dhruman Gandhi, Maharashtra (IN); Dattaprasad Narayan Kamat, Maharashtra (IN)

(21) Appl. No.: 18/542,074

(22) Filed: Dec. 15, 2023

Related U.S. Application Data
(63) Continuation of application No. PCT/IB2022/054796, filed on May 23, 2022.
Application No. PCT/IB2022/054796 is a continuation-in-part of application No. 17/799,128, filed on Aug. 11, 2022.

(30) Foreign Application Priority Data
Feb. 21, 2020 (IN) 202021007516
Jun. 16, 2021 (IN) 202123026879

(51) Int. Cl. G06Q 30/018; G06F 16/955; G06V 10/70

(52) U.S. Cl. CPC G06Q 30/0185; G06F 16/9566; G06V 10/70; G06V 2201/09

(57) ABSTRACT

The present disclosure relates to the field of product authentication and verification and discloses a system (100) and method (200) to authenticate a product. The system (100) comprises a memory (102), a scanning module (104), a product identification module (108), a first re-direction module (106) and a second re-direction module (110). The product identification module (108) detects a design printed on the packaging of products and identifies products based on pre-trained machine learning model and detected design. The scanning module (104) facilitates user to scan visual codes printed on products and extracts UIDs and verification URLs from scanned visual code. The first re-direction module (106) receives extracted UID and verification URL if product is identified and screens extracted URL to identify its authenticity. The second re-direction module (110) re-directs users to a third-party verification platform at the embedded URL for product verification if product is not identified.

### CROSS-REFERENCE TO RELATED APPLICATION

This application is a continuation of PCT Patent Application No. PCT/IB2022/054796 filed May 23, 2022, entitled “A System to Authenticate a Product and a Method Thereof,” which claims priority from Indian Patent application No. 202123026879 filed Jun. 16, 2021, entitled “A System to Authenticate a Product and a Method Thereof.” This application is also a Continuation-in-Part of U.S. patent application Ser. No. 17/799,128 filed Aug. 11, 2022, entitled “A System to Authenticate a Product and a Method Thereof,” which is a national phase of PCT Patent Application No. PCT/IB2020/052853 filed Mar. 26, 2020, entitled “A System to Authenticate a Product and a Method Thereof,” which claims priority from Indian Patent Application No. 202021007516 filed Feb. 21, 2020, entitled “A System to Authenticate a Product and a Method Thereof,” the entire disclosures of each of which are hereby incorporated by reference herein.

### FIELD

The present invention relates to a system and method for product authentication.

As used in the present disclosure, the following terms are generally intended to have the meaning as set forth below, except to the extent that the context in which they are used indicate otherwise.

The expression “visual code” used hereinafter in this specification refers to, but is not limited to, a random number, a bar code, a URL QR Code, a PDF QR Code, an image QR Code, an RFID code, SQRC, a frame QR, a micro QR code, an iQR code, a text QR code, a datamatrix code, and radioactive codes.

### BACKGROUND

The background information herein below relates to the present disclosure but is not necessarily prior art.

Currently available product authentication systems and methods facilitate a consumer to verify the authenticity of a product with the help of a unique code provided on the packaging of the product. The unique code is either visible or hidden under a scratch label or within the packaging, and is accessible to the consumers to verify authenticity of their purchase. Each of these unique codes may be encoded with a unique number. The consumer may verify this unique number in various ways which includes scanning the unique code printed on the packaging via a mobile app to authenticate the code in-app. Alternatively, a web URL is encoded into the visual code which after scanning launches the webpage of the verification authority and verifies the code in the mobile browser. Alternatively, the visual code can be entered on a webpage provided by the verification authority/brand owner to verify the authenticity of the product. The unique code may or may not be terminated once scanned for the first time. By terminating a unique code, any subsequent scan of the same unique code be provided on a different product will reveal that the unique code has already been scanned or verified once and hence could be a counterfeit. Thus, a counterfeiter making copies of a genuine unique code can be deterred.

However, the drawback of the conventional system and method is that a counterfeiter could create a completely parallel system for verification to easily mislead the consumer to a counterfeit portal. Moreover, a similar sounding name or verification number of the brand or the product may deceive a consumer into verifying a counterfeit product on a fake authentication portal.

To avoid this, the Indian Application 202021007516 teaches a system that uses machine learning and image recognition-based techniques to check whether or not a product is a registered product and verify the authenticity of the product. However, the checking and verification are performed on a server. Therefore, for authentication of products, each product image needs to be sent to the server irrespective of whether it is a registered product or not. The decision on whether or not it is a registered product with a QR code meant for authentication is not taken on the mobile device (edge) itself, thus putting a lot of burden on the server, which is not desired.

There is, therefore, felt a need to develop a system and method that can address the aforementioned drawbacks of the conventional system to authenticate a product and a method thereof.

### OBJECTS

Some of the objects of the present disclosure, which at least one embodiment herein satisfies, are as follows:

An object of the present disclosure is to provide a system to authenticate a product and a method thereof.

Another object of the present disclosure is to provide a system and method to authenticate a product that allows a streamlined and automated verification of a product.

Yet another object of the present disclosure is to provide a system and method for product authentication that is reliable.

Still another object of the present disclosure is to provide a system and method for product authentication which avoids errors in accessing the genuine websites and/or systems for verification and authentication.

Yet another object of the present disclosure is to provide a system and method for product authentication that prevents redirection to fake parallel verification portals and/or systems.

Still another object of the present disclosure is to provide a system and method for product authentication that identifies a counterfeit product.

Yet another object the present disclosure is to provide a system and method for product authentication that determines whether or not a product is a registered product at the edge level i.e. in the mobile device itself.

Other objects and advantages of the present disclosure will be more apparent from the following description, which is not intended to limit the scope of the present disclosure.

### SUMMARY

The present disclosure envisages a system to authenticate a product. The system comprises a memory, a scanning module, a product identification module, a first re-direction module and a second re-direction module.

The memory is configured to store a machine learning model trained using image data of a plurality of the products.

The product identification module is configured to detect a design printed on the packaging of the products. The design comprises at least one of an artwork, a text in and around a visual code, a brand logo, and a relative position and size of the visual code and the artwork, text, or brand logo. The product identification module is further configured to cooperate with the memory to identify the products based on the pre-trained machine learning model and the detected design. In an embodiment, the product identification module is configured to first detect the visual code printed on product packaging, and then use the detected visual code's location and scale as a reference for detecting and identifying the design printed on product packaging for product identification.

In an embodiment, the product identification module includes a second identification unit configured to receive the detected design and use the pre-trained machine learning model to identify the product based on the detected design.

In an embodiment, the product identification module includes a flag generator configured to cooperate with the memory to receive the detected design, recognize the products using said pre-trained machine learning model, and generate a flag signal on successful recognition of said products. The flag generator is further configured to transmit the flag signal to the first re-direction module for appending URL for forceful redirection.

The scanning module is configured to facilitate a user to scan the visual codes printed on the products, each visual code including an embedded information comprising a unique identification number (UID) of associated product and a verification URL. The scanning module is further configured to extract the UIDs and the verification URLs from the scanned visual code.

The first re-direction module is configured to cooperate with the scanning module and the product identification module to receive the extracted UID and the verification URL if the product is identified, and is further configured to screen the extracted URL to identify the products authenticity and:
re-direct the user to a verification server at the extracted URL for product verification if the URL is found to be authentic; or
append the extracted contents of the code (UID+URL) to the stored genuine server URL, if the extracted URL is found to be spurious and forcefully re-direct users to the genuine verification server at the appended URL for product verification.

In an embodiment, the verification server comprises a first repository and a verification module. The first repository is configured to store a list of registered products and UIDs associated with each of the products. The verification module is configured to receive the extracted UID from the first re-direction module, and crawl through the list stored in the first repository to identify whether or not the UID exists in the list,
i. if the UID is identified in the list, the verification module is configured to generate a verification successful message and optionally delete/kill the identified UID from the list; and
ii. if the UID is not identified in the list, the verification module is configured to generate a verification failure message.

In an embodiment, the first re-direction module includes a receiving unit, a screening unit, a forwarding unit and an appending unit.

The receiving unit is configured to cooperate with the scanning module and the product identification module to receive the extracted UID and the verification URL if the product is identified. The screening unit comprises a parser and an authenticator.

The parser is configured to parse through the extracted URL and generate at least one token. The authenticator is configured to cooperate with the parser to receive the generated token and compare the received token with a standard pre-stored string to determine whether or not the URL authentic.

The forwarding unit is configured to cooperate with the screening unit to re-direct the user to the verification server at the extracted URL for product verification if the URL is found to be authentic when the generated token is same as the standard pre-stored string.

The appending unit is configured to append the extracted UID to the extracted URL if the URL is found to be spurious when the generated token is not same as the standard pre-stored string. The appending unit is further configured to forcefully re-direct the users to the verification server at the appended URL for product verification.

The second re-direction module is configured to cooperate with the scanning module to receive the extracted UID and the verification URL, and is further configured to cooperate with the product identification module to re-direct users to a third-party verification platform at the embedded URL for product verification if the product is not identified.

In an embodiment, the product identification module, the scanning module, the first re-direction module and the second re-direction module are configured in a user device and implemented using one or more processor(s) of the user device.

In another embodiment, the scanning module is configured in a user device, and the product identification module, the first re-direction module and the second re-direction module are configured in the verification server and implemented using one or more processor(s) of the verification server.

The verification failure message and the verification successful message are displayed on the user device indicating whether or not the product is a verified product to the user scanning the product.

The present disclosure envisages a method for authenticating a product. The method comprises the following steps:
storing, in a memory, a machine learning model trained using image data of a plurality of the products;
detecting, by a product identification module, a design printed on the packaging of the products, the design comprising at least one of an artwork, a text in and around a visual code, a brand logo, and a relative position and size of the visual code and the artwork, text, or brand logo;
identifying, by the product identification module, the products based on the pre-trained machine learning model and the detected design;
facilitating, by a scanning module, at least one user to scan the visual codes printed on the products, each visual code including an embedded information comprising a unique identification number (UID) of associated product and a verification URL;
extracting, by the scanning module, the UIDs and the verification URLs from the scanned visual code;
receiving, by a first re-direction module, the extracted UID and the verification URL if the product is identified;
screening, by the first re-direction module, the extracted URL to identify its authenticity;
re-directing, by the first re-direction module, the user to a verification server at the extracted URL for product verification if the URL is found to be authentic; or
appending, by the first re-direction module, the extracted UID to the extracted URL if the URL is found to be spurious and forcefully re-directing the user to the verification server at the appended URL for product verification;
receiving, by a second re-direction module, the extracted UID and the verification URL; and
re-directing, by the second re-direction module, the user to a third-party verification platform at the embedded URL for product verification if the product is not identified.

### BRIEF DESCRIPTION OF THE DRAWINGS

A system to authenticate a product and a method thereof, of the present disclosure will now be described with the help of the accompanying drawing, in which:

FIG. 1 illustrates a block diagram of a system to authenticate a product, in accordance with the present disclosure; and

FIGS. 2a and 2b illustrate a flow diagram depicting a method to authenticate a product, in accordance with the present disclosure.

LIST OF REFERENCE NUMERALS

| | |
|---|---|
| 100 | system |
| 102 | memory |
| 104 | scanning module |
| 106 | first re-direction module |
| 108 | product identification module |
| 110 | second re-direction module |
| 112 | user device |
| 114 | verification server |
| 116 | first repository |
| 118 | verification module |
| 120 | Flag generator |
| 126 | second identification unit |
| 128 | receiving unit |
| 130 | screening unit |
| 132 | parser |
| 134 | authenticator |
| 136 | forwarding unit |
| 138 | appending unit |

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details, are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

When an element is referred to as being “mounted on,” “engaged to,” “connected to,” or “coupled to” another element, it may be directly on, engaged, connected or coupled to the other element. As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

Terms such as “inner,” “outer,” “beneath,” “below,” “lower,” “above,” “upper,” and the like, may be used in the present disclosure to describe relationships between different elements as depicted from the figures.

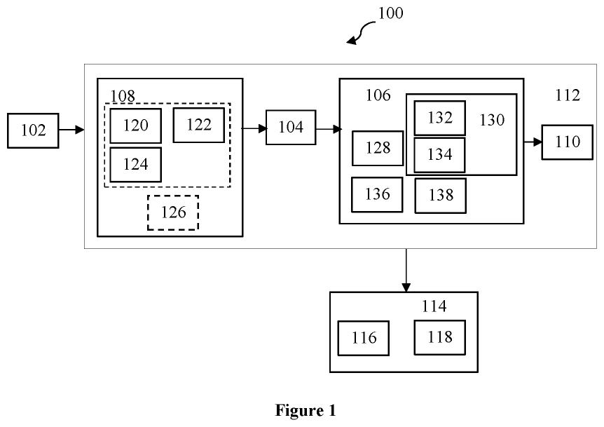

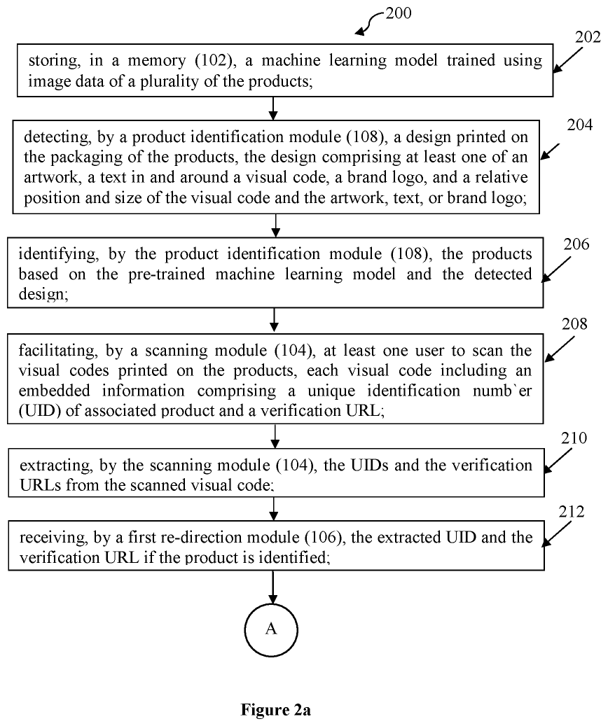

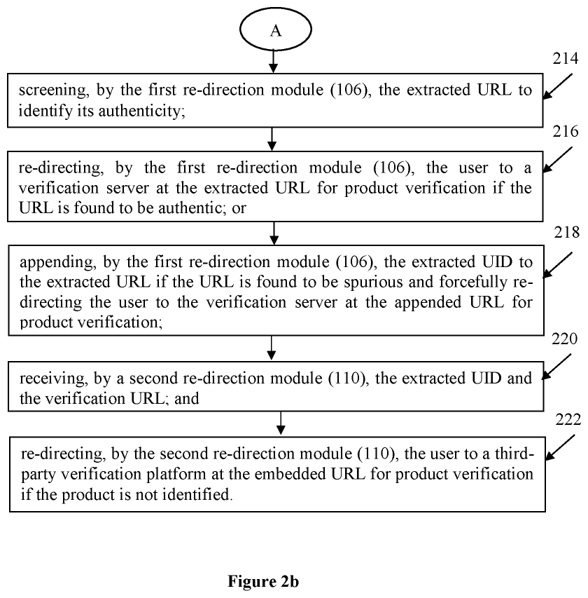

A system (hereinafter referred to as “system (100”)) and method (hereinafter referred to as “method (200)) to authenticate a product of the present disclosure, is described with reference to FIG. 1 through FIG. 2b.

Referring to FIG. 1, the system (100) comprises a memory (102), a scanning module (104), a product identification module (108), a first re-direction module (106) and a second re-direction module (110).

The memory (102) is configured to store a machine learning model trained using image data of a plurality of the products.

The product identification module (108) is configured to detect a design printed on the packaging of the products. The design comprises at least one of an artwork, a text in and around a visual code, a brand logo, and a relative position and size of the visual code and the artwork, text, or brand logo. The product identification module (108) is further configured to cooperate with the memory (102) to identify the products based on the pre-trained machine learning model and the detected design.

In one embodiment, the product identification module (108) directly detects the design, for example, a logo printed on the packaging to identify the products. In an alternate embodiment, the product identification module (108) detects the visual code printed on the packaging and then detects design printed around the visual code to identify the products.

The visual code can be, but is not limited to a QR code, a PDF QR Code, an image QR Code, an RFID code, SQRC, a frame QR, a micro QR code, an iQR code, a text QR code, a radioactive code, a watermark, a texture, a barcode, an invisible UV image, and a randomly generated number, or a combination thereof. The unique code can be overt or covert. The unique code can be over the surface of the product or hidden under a removable layer on the surface of the product.

The scanning module (104) is configured to facilitate a user to scan the visual codes printed on the products, each visual code including an embedded information comprising a unique identification number (UID) of associated product and a verification URL. The scanning module (104) is further configured to extract the UIDs and the verification URLs from the scanned visual code.

The first re-direction module (106) is configured to cooperate with the scanning module (104) and the product identification module (108) to receive the extracted UID and the verification URL if the product is identified, and is further configured to screen the extracted URL to identify its authenticity and:
re-direct the user to a verification server at the extracted URL for product verification if the URL is found to be authentic; or
append the extracted contents of the code (UID+URL) to the stored genuine server URL, if the extracted URL is found to be spurious and forcefully re-direct users to the genuine verification server at the appended URL for product verification.

In order to append the authorized server URL, one of the below methods may be followed—
1. Remove protocols such as “http:”, “https:”, “/” from the URL
2. If the QR code content doesn't contain base URL, append a known counterfeit string in the contents.
3. Modify regex to correctly validate if the content after “/” is a valid sequence number or not.
4. In case the QR code is genuine and the content has the authorized URL itself, forward the entire content as is to the server without any modifications.

In an embodiment, the verification server (114) comprises a first repository (116) and a verification module (118). The first repository (116) is configured to store a list of registered products and UIDs associated with each of the products. The verification module (118) is configured to receive the extracted UID from the first re-direction module (106), and crawl through the list stored in the first repository (116) to identify whether or not the UID exists in the list,
if the UID is identified in the list, the verification module (118) configured to generate a verification successful message and optionally delete/kill the identified UID from the list; and
if the UID is not identified in the list, the verification module (118) configured to generate a verification failure message.

In a preferred embodiment, the product identification module (108) includes a second identification unit (126) configured to receive the detected design and use the pre-trained machine learning model to identify the product based on the detected design. In this case, the machine learning module is specifically trained to identify the products that are registered with the system (100). If the machine learning model identifies the product, the product identification module (108) triggers the scanning module (104) to scan the visual code next to the recognized artwork, and send the content of the visual code (for e.g. UID) to the designated URL. The product verification will be done on the server (114) and the result will be displayed accordingly.

In another embodiment, the product identification module (108) includes a flag generator (120). The flag generator (120) is configured to cooperate with the memory (102) to receive the detected design, recognize the products using the pre-trained machine learning model, and generate a flag signal on successful recognition of the products. The flag generator (120) is further configured to transmit said flag signal to the first re-direction module (106) for appending URL for forceful redirection.

In this case, a generic machine-learning based application may be used. The application may thus be designed to identify all products irrespective of whether or not they are meant to be verified. Therefore, the product identification module (108) of the system (100) and the pre-trained machine learning model may be embedded in the application in the form of an sdk file. Thus, to determine whether or not a product is meant to be verified by the system (100), the product identification module (108) simply generates a flag signal indicating that it also recognizes the product. If the flag signal is generated, the content of the visual code (for e.g. UID) is appended with the designated URL and sent to the verification server (114) for verification.

In another embodiment, the product identification module (108) first detects the visual code and then captures the image of the design around the detected visual code for product identification. In this scenario, the visual code's location and scale is used as a reference for detecting and identifying the design for product identification. The information regarding location and scale of the visual code helps in identifying the product more accurately and redirecting it to the authorized verification server (114). In this case, if there is no visual code on the product, the product identification module (108) will simply function as an image recognition application.

In another embodiment, if visual code content doesn't contain the authorized base URL, then the product will be declared as a fake product (without sending request to backend). In this scenario, the first re-direction module (106) is not required to send the content of the QR code for verification. Once the product is declared as a counterfeit, the user may be asked to share additional information such as store name, contact details etc. which will be shared with the brand for further investigations.

In an embodiment, the first re-direction module (106) includes a receiving unit (128), a screening unit (130), a forwarding unit (136) and an appending unit (138).

The receiving unit (128) is configured to cooperate with the scanning module (104) and the product identification module (108) to receive the extracted UID and the verification URL if the product is identified. The screening unit (130) comprises a parser (132) and an authenticator (134).

The parser (132) is configured to parse through the extracted URL and generate at least one token. The authenticator (134) is configured to cooperate with the parser to receive the generated token and compare the received token with a standard pre-stored string to determine whether or not the URL is authentic.

The forwarding unit (136) is configured to cooperate with the screening unit to re-direct the user to the verification server (114) at the extracted URL for product verification if the URL is found to be authentic when the generated token is same as the standard pre-stored string.

The appending unit (138) is configured to append the extracted UID to the extracted URL if the URL is found to be spurious when the generated token is not same as the standard pre-stored string. The appending unit (138) is further configured to forcefully re-direct the users to the verification server at the appended URL for product verification.

The second re-direction module (110) is configured to cooperate with the scanning module (104) to receive the extracted UID and the verification URL, and is further configured to cooperate with the product identification module (108) to re-direct users to a third-party verification platform at the embedded URL for product verification if the product is not identified.

In a preferred embodiment, the memory (102) and the scanning module (104) are the elements of the user device (112). The user device (112) may be any electronic device selected from the group consisting of, but is not limited to, a mobile phone, a smartphone, an iPad, a tablet, a palmtop, code scanning cameras, smart watch and code scanning equipment.

The product identification module (108), the scanning module (104), the first re-direction module (106) and the second re-direction module (110) are configured in a user device (112) and implemented using one or more processor(s) of the user device (112). The product identification module (108), the scanning module (104), the first re-direction module (106) and the second re-direction module (110) may be configured in the user device (112) in the form of an application. The identification of product and the decision on whether or not the identified product with a QR code is meant for authentication is taken on the user device (112) (edge) itself, thereby relieving the server of additional burden.

In an alternate embodiment, the scanning module (104) is configured in a user device (112), and the product identification module (108), the first re-direction module (106) and the second re-direction module (110) are configured in the verification server (114) and implemented using one or more processor(s) of the verification server (114). However, this configuration increases the load/burden on the server (114), as the checking and verification are performed on the server (114). Therefore, for authentication of products, each product image needs to be sent to the server (114) irrespective of whether the product is meant to be verified or not.

The verification failure message and the verification successful message are displayed on the user device (112) indicating whether or not the product is a verified product.

The processors disclosed herein may be general-purpose processors, Field Programmable Gate Arrays (FPGAs), Application Specific Integrated Circuits (ASICs), Digital Signal Processors (DSPs), and/or the like. The processors may be configured to retrieve data from and/or write data to a memory/repository. The memory/repository can be for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, cloud storage, and/or so forth.

FIGS. 2a and 2b illustrate a flow diagram of the method (200) for authenticating a product. The method comprises the following steps:
Step 202: storing, in a memory (102), a machine learning model trained using image data of a plurality of the products;
Step 204: detecting, by a product identification module (108), a design printed on the packaging of the products, the design comprising at least one of an artwork, a text in and around a visual code, a brand logo, and a relative position and size of the visual code and the artwork, text, or brand logo;
Step 206: identifying, by the product identification module (108), the products based on the pre-trained machine learning model and the detected design;
Step 208: facilitating, by a scanning module (104), at least one user to scan the visual codes printed on the products, each visual code including an embedded information comprising a unique identification number (UID) of associated product and a verification URL;
Step 210: extracting, by the scanning module (104), the UIDs and the verification URLs from the scanned visual code;
Step 212: receiving, by a first re-direction module (106), the extracted UID and the verification URL if the product is identified;
Step 214: screening, by the first re-direction module (106), the extracted URL to identify its authenticity;
Step 216: re-directing, by the first re-direction module (106), the user to a verification server at the extracted URL for product verification if the URL is found to be authentic; or
Step 218: appending, by the first re-direction module (106), the extracted UID to the extracted URL if the URL is found to be spurious and forcefully re-directing the user to the verification server at the appended URL for product verification;
Step 220: receiving, by a second re-direction module (110), the extracted UID and the verification URL; and
Step 222: re-directing, by the second re-direction module (110), the user to a third-party verification platform at the embedded URL for product verification if the product is not identified.

In an exemplary embodiment, a user with the help of the user device (112) having a product identification module (108) detects a design printed on the packaging of the products and identifies the products based on the pre-trained machine learning model and the detected design. A scanning module (104) in the user device (112) facilitates user to scan the visual codes printed on the products, each visual code including an embedded information comprising a unique identification number (UID) of associated product and a verification URL, and extract the UIDs and the verification URLs from the scanned visual code. The user is either re-directed to a verification server for product verification if the URL is found to be authentic or the extracted UID is appended to the extracted URL if the URL is found to be spurious and the user is forcefully re-directed to the verification server (114) for product verification. If the product is not identified, the user is re-directed to a third-party verification platform at the embedded URL for product verification. Hence, the verification server verifies the authenticity of the product and accordingly generates a verification failure or success message. The message indicating if the product is authentic or fake is displayed on the user device (112) for user to be notified.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

### Technical Advancements

The present disclosure described herein above has several technical advantages including, but not limited to, system to authenticate a product and a method thereof, which:
allows a streamlined and automated verification of a product;
is reliable;
avoids errors in accessing the genuine websites and/or systems for verification and authentication;
prevents redirection to fake parallel verification portals and/or systems;
identifies a counterfeit product; and
that determines whether or not a product is a registered product at the edge level i.e. in the mobile device itself.

The foregoing disclosure has been described with reference to the accompanying embodiments which do not limit the scope and ambit of the disclosure. The description provided is purely by way of example and illustration.

One of the objects of the Patents Law is to provide protection to new technologies in all fields and domain of technologies. The new technologies shall or may contribute to the country economy growth by way of involvement of new efficient and quality method or product manufacturing in India.

To provide the protection of new technologies by patenting the product or process will contribute significantly to the innovation development in the country. Further by granting patent, the patentee can contribute to manufacturing the new product or new process of manufacturing by himself or by technology collaboration or through the licensing.

The applicant submits that the present disclosure will contribute to country economy, which is one of the purposes to enact the Patents Act, 1970. The product in accordance with present invention will be in great demand in country and worldwide due to novel technical features of a present invention is a technical advancement in detecting the authentic products. The technology in accordance with present disclosure will provide a novel and easy way for the detection of fake products.

The product will contribute new concept in detecting real products for the user not to get fooled wherein the patented system and method will be used. The present disclosure will replace the whole concept of verifying the authenticity of products from decades. The product is developed in the national interest and will contribute to country economy.

The economy significance details requirement may be called during the examination. Only after filing of this Patent application, the applicant can work publicly related to present disclosure product/process/method. The applicant will disclose all the details related to the economic significance contribution after the protection of invention.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. A system (100) to authenticate a product, said system (100) comprising:
a memory (102) configured to store a machine learning model trained using image data of a plurality of said products;
a product identification module (108) configured to detect a design printed on the packaging of said products, said design comprising at least one of an artwork, a text in and around a visual code, a brand logo, and a relative position and size of said visual code and said artwork, text, or brand logo, said product identification module (108) further configured to cooperate with said memory (102) to identify said products based on said pre-trained machine learning model and said detected design;
a scanning module (104) configured to facilitate at least one user to scan said visual codes printed on said products, each visual code including an embedded information comprising a unique identification number (UID) of associated product and a verification URL, said scanning module (104) further configured to extract said UIDs and said verification URLs from said scanned visual code;
a first re-direction module (106) configured to cooperate with said scanning module (104) and said product identification module (108) to receive said extracted UID and said verification URL if said product is identified, and further configured to screen said extracted URL to identify said product's authenticity and:
re-direct said user to a verification server (114) at said extracted URL for product verification if said URL is found to be authentic; or
append said extracted contents of said visual code (UID and verification URL) to a pre-stored URL of said verification server (114) if said extracted URL is found to be spurious and forcefully re-direct said user to said genuine verification server (114) at said appended URL for product verification; and
a second re-direction module (110) configured to cooperate with said scanning module (104) to receive said extracted UID and said verification URL, and further configured to cooperate with said product identification module (108) to re-direct said user to a third-party verification platform at an embedded URL for product verification if said product is not identified.

2. The system (100) as claimed in claim 1, wherein said verification server (114) comprises:
a first repository (116) configured to store a list of registered products and UIDs associated with each of said products; and
a verification module (118) configured to receive said extracted UID from said first re-direction module (106), and crawl through said list stored in said first repository (116) to identify whether or not said UID exists in said list,
i. if said UID is identified in said list, said verification module (118) configured to generate a verification successful message and optionally delete/kill said identified UID from said list; and
ii. if said UID is not identified in said list, said verification module (118) configured to generate a verification failure message.

3. The system (100) as claimed in claim 1, wherein said product identification module (108), said scanning module (104), said first re-direction module (106) and said second re-direction module (110) are configured in a user device (112) and implemented using one or more processor(s) of said user device (112).

4. The system (100) as claimed in claim 3, wherein either of said verification failure message or said verification successful message is displayed on said user device (112) indicating whether or not said product is a verified product.

5. The system (100) as claimed in claim 1, wherein said scanning module (104) is configured in a user device (112), said product identification module (108), said first re-direction module (106) and said second re-direction module (110) are configured in said verification server (114) and implemented using one or more processor(s) of said verification server (114).

6. The system (100) as claimed in claim 1, wherein said product identification module (108) includes a second identification unit (126) configured to receive said detected design and use said pre-trained machine learning model to identify said product based on said detected design.

7. The system (100) as claimed in claim 1, wherein said product identification module (108) includes a flag generator (120) configured to cooperate with said memory (102) to receive said detected design, recognize said products using said pre-trained machine learning model, and generate a flag signal on successful recognition of said products, said flag generator (120) further configured to transmit said flag signal to said first re-direction module (106) for appending URL for forceful redirection.

8. The system (100) as claimed in claim 1, wherein said first re-direction module (106) includes:
a receiving unit (128) configured to cooperate with said scanning module (104) and said product identification module (108) to receive said extracted UID and said verification URL if said product is identified;
a screening unit (130) comprising:
i. a parser (132) configured to parse through said extracted URL and generate at least one token; and
ii. an authenticator (134) configured to cooperate with said parser to receive said generated token and compare said received token with a standard pre-stored string to determine whether or not said URL authentic,
a forwarding unit (136) configured to cooperate with said screening unit to re-direct said user to said verification server (114) at said extracted URL for product verification if said URL is found to be authentic when said generated token is same as said standard pre-stored string; and
an appending unit (138) configured to append said extracted contents of said visual code (UID and verification URL) to said a pre-stored URL of said verification server (114) if said extracted URL is found to be spurious, when said generated token is not same as said standard pre-stored string, said appending unit (138) further configured to forcefully re-direct said user to said genuine verification server (114) at said appended URL for product verification.

9. The system (100) as claimed in claim 1, wherein said product identification module (108) is configured to first detect said visual code printed on product packaging, and then use the detected visual code's location and scale as a reference for detecting and identifying said design printed on product packaging for product identification.

10. A method (200) for authenticating a product, said method (200) comprising the following steps:
storing (202), in a memory (102), a machine learning model trained using image data of a plurality of said products;
detecting (204), by a product identification module (108), a design printed on the packaging of said products, said design comprising at least one of an artwork, a text in and around a visual code, a brand logo, and a relative position and size of said visual code and said artwork, text, or brand logo;
identifying (206), by said product identification module (108), said products based on said pre-trained machine learning model and said detected design;
facilitating (208), by a scanning module (104), at least one user to scan said visual codes printed on said products, each visual code including an embedded information comprising a unique identification number (UID) of associated product and a verification URL;
extracting (210), by said scanning module (104), said UIDs and said verification URLs from said scanned visual code;
receiving (212), by a first re-direction module (106), said extracted UID and said verification URL if said product is identified;
screening (214), by said first re-direction module (106), said extracted URL to identify its authenticity;
re-directing (216), by said first re-direction module (106), said user to a verification server at said extracted URL for product verification if said URL is found to be authentic; or
appending (218), by said first re-direction module (106), said extracted UID to said extracted URL if said URL is found to be spurious and forcefully re-directing said user to said verification server at said appended URL for product verification;
receiving (220), by a second re-direction module (110), said extracted UID and said verification URL; and
re-directing (222), by said second re-direction module (110), said user to a third-party verification platform at said embedded URL for product verification if said product is not identified.
